(19) United States
(12) Patent Application Publication
(10) Pub. No.: US 2020/0334033 A1
(43) Pub. Date: Oct. 22, 2020

(54) APPARATUS AND METHOD FOR PROVIDING UPDATE IN VEHICLE

(71) Applicants: Hyundai Motor Company, Seoul (KR); Kia Motors Corporation, Seoul (KR)

(72) Inventors: Dong Youl Lee, Seoul (KR); Myeong Gyu Jeong, Seoul (KR); Jae Am Seo, Seongnam (KR)

(21) Appl. No.: 16/688,036

(22) Filed: Nov. 19, 2019

(30) Foreign Application Priority Data
Apr. 16, 2019 (KR) 10-2019-0044487

(51) Int. Cl. G06F 8/65; G06F 8/658; G07C 5/08

(52) U.S. Cl. CPC G06F 8/66; G07C 5/08; G06F 8/658

(57) ABSTRACT

An apparatus for providing an update in a vehicle is provided. The apparatus includes a communication interface that communicates wiredly or wirelessly with an external device, one or more peripheral controllers, and a controller to be updated, electrically connected with the communication interface and the one or more peripheral controllers. The controller receives an update request for an update, through the communication interface from the external device, receives information indicating a remaining storage space of each of the one or more peripheral controllers, when the update request is received, divides previous version data of the controller to be updated, based on the information indicating the remaining storage space, and transmits the divided previous version data to the one or more peripheral controllers.

### CROSS-REFERENCE TO RELATED APPLICATION

This application is claims the benefit of priority to Korean Patent Application No. 10-2019-0044487, filed on Apr. 16, 2019, the entire contents of which are incorporated herein by reference.

### TECHNICAL FIELD

The present disclosure relates to technologies of updating software of a controller loaded into a vehicle using a mobile terminal of a user, and more particularly, to an apparatus and method for storing previous version software of a controller to be updated for rollback when an external device connected with a vehicle is used as an update management controller.

### BACKGROUND

With the development of the auto industry, a system for providing various services using wireless communication technology has been developed to provide convenience to drivers. For example, a vehicle may update software of a controller loaded into the vehicle, via wireless communication. A management controller that manages an update may be required for the update. To save costs for loading the management controller, a system of the vehicle is connected with a mobile terminal of a user to use the mobile terminal as a management controller, thus saving costs for loading the management controller and communication costs.

Meanwhile, to support an update of a controller, a device for restoring software to a previous version when an update fails may be required for safety. To restore the software to the previous version, previous version software need to be stored in a memory. When the mobile terminal is used as the management controller, it may be difficult to store the previous version software. Thus, when a connection between the mobile terminal and the vehicle is lost while an update is performed, due to an intention of the user or a communication fault, it may be difficult to roll back software of a controller to be updated to a previous version.

### SUMMARY

The present disclosure provides an apparatus and method for storing previous version software of a controller to be updated for rollback when an external device connected with a vehicle is used as an update management controller.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for providing an update in a vehicle may include: a communication interface configured to communicate via wire or wirelessly with an external device, one or more peripheral controllers, and a controller to be updated, electrically connected with the communication interface and the one or more controllers. The controller to be updated may be configured to receive an update request for the controller to be updated, through the communication interface from the external device, receive information that indicates a remaining storage space of each of the one or more peripheral controllers, when the update request is received, divide previous version data of the controller to be updated, based on the information of the remaining storage space, and transmit the divided previous version data to the one or more peripheral controllers.

According to an exemplary embodiment, the controller to be updated may be configured to perform rollback using the previous version data stored in the one or more peripheral controllers, when a connection with the external device is lost while an update according to the update request is in progress. The controller to be updated may be configured to sequentially receive the divided previous version data from the one or more peripheral controllers.

Additionally, the controller to be updated may be configured to receive update data regarding the controller to be updated from the external device, when the transmission of the divided previous version data is completed and perform an update using the update data. The controller to be updated may be configured to request the one or more peripheral controllers to delete the divided previous version data, when an update according to the update request is completed.

Further, the controller to be updated may be configured to transmit a notification message for providing a notification that an update is in progress to the one or more peripheral controllers, while the update according to the update request is in progress. The controller to be updated may be configured to determine a peripheral controller to transmit the previous version data among the one or more peripheral controllers based on the information indicating the remaining storage space and a size of the previous version data.

According to an exemplary embodiment, the external device may be a mobile communication device. The controller to be updated may be configured to receive update data for the controller to be updated, via the mobile communication device from a server. The controller may be connected with the external device via a universal serial bus (USB) port. According to an exemplary embodiment, the controller may be connected with the external device via Bluetooth communication.

According to another aspect of the present disclosure, a method for providing an update in a vehicle may include: receiving an update request for a controller to be updated, from an external device, receiving information indicating a remaining storage space of each of one or more peripheral controllers, when the update request is received, dividing previous version data of the controller to be updated, based on the information indicating the remaining storage space, and transmitting the divided previous version data to the one or more peripheral controllers.

The method may further include performing rollback using the previous version data stored in the one or more peripheral controllers, when a connection with the external device is lost while an update according to the update request is in progress. In addition, the method may include receiving update data about the controller to be updated from the external device, when the transmission of the divided previous version data is completed and performing an update using the update data.

The method may further include requesting the one or more peripheral controllers to delete the divided previous version data, when an update according to the update request is completed and determining a peripheral controller to transmit the previous version data among the one or more peripheral controllers based on the information indicating the remaining storage space and a size of the previous version data.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating an environment where an apparatus for providing an update in a vehicle is operated, according to an exemplary embodiment of the present disclosure;

FIG. 2 is a block diagram illustrating a configuration of an apparatus for providing an update in a vehicle according to an exemplary embodiment of the present disclosure;

FIG. 3 is a flowchart illustrating a method for providing an update in a vehicle according to an exemplary embodiment of the present disclosure;

FIG. 4 is a signal sequence diagram illustrating a method for providing an update in a vehicle according to an exemplary embodiment of the present disclosure;

FIG. 5 is a flowchart illustrating a method for providing an update in a vehicle according to an exemplary embodiment of the present disclosure;

FIG. 6 is a drawing illustrating an exemplary operation of an apparatus for providing an update in a vehicle according to an exemplary embodiment of the present disclosure;

FIG. 7 is a drawing illustrating an exemplary operation of an apparatus for providing an update in a vehicle according to an exemplary embodiment of the present disclosure; and

FIG. 8 is a block diagram illustrating a configuration of a computing system according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

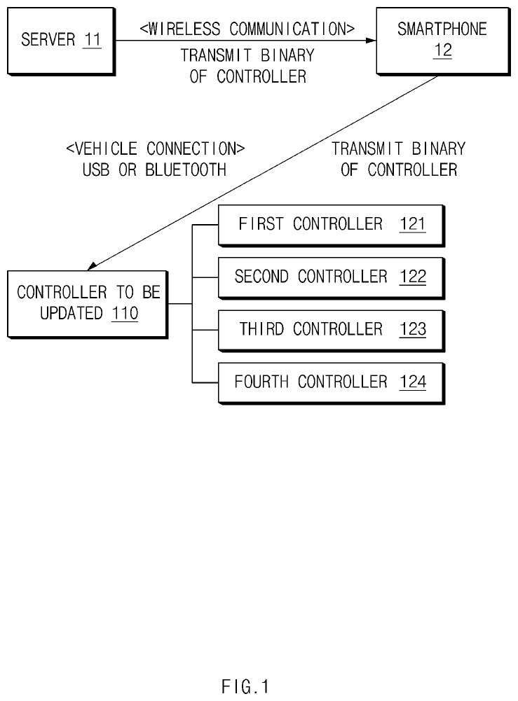

FIG. 1 is a drawing illustrating an exemplary environment where an apparatus for providing an update in a vehicle is operated, according to an exemplary embodiment of the present disclosure. Referring to FIG. 1, a server 11 may be configured to store a binary for a controller of the vehicle. A smartphone 12 may be connected with the server 11 via wireless communication. The smartphone 12 may be connected with a controller 110 to be updated, loaded into the vehicle, via a universal serial bus (USB) or Bluetooth.

The smartphone 12 may function as an update management controller of the vehicle. In particular, the smartphone 12 may be configured to receive a binary of the controller 110 to be updated, via wireless communication. The smartphone 12 may be configured to transmit the received binary to the controller 110 to be updated, via a USB or Bluetooth. Prior to initiating an update using the received binary, the controller 110 to be updated may be configured to store a previous version binary in another component (e.g., database) in preparation for rollback. For example, the controller 110 may be configured to divide the previous version binary and store the divided binaries in a first controller 121, a second controller 122, a third controller 123, and a fourth controller 124. By using storage spaces of the first to fourth controllers 121 to 124, since there is no need to obtain a separate storage space for rollback, costs may be saved.

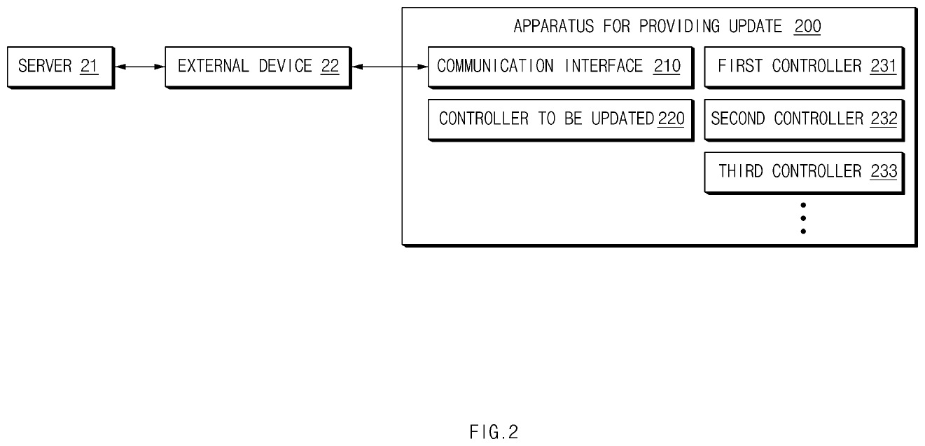

FIG. 2 is a block diagram illustrating a configuration of an apparatus for providing an update in a vehicle according to an exemplary embodiment of the present disclosure. Referring to FIG. 2, an apparatus 200 for providing an update in a vehicle according to an exemplary embodiment of the present disclosure may include a communication interface 210, a controller 220 to be updated, a first controller 231, a second controller 232, and a third controller 233. In FIG. 2, an exemplary embodiment is exemplified as the apparatus 200 for providing the update may include the first controller 231, the second controller 232, and the third controller 232. However, exemplary embodiments are not limited thereto. For example, the apparatus 200 for providing the update may include any number of controllers. The apparatus 200 for providing the update may be loaded into the vehicle.

In particular, the communication interface 210 may be configured to communicate wiredly or wirelessly with an external device 22. For example, the communication interface 210 may be a USB or a Bluetooth module connectable with the external device 22. The controller 220 to be updated may be electrically connected with the communication interface 210. The controller 220 may be one of various controllers loaded into the vehicle. The first controller 231, the second controller 232, and the third controller 233 may be various controllers mounted within the vehicle. Each of the first controller 231, the second controller 232, and the third controller 233 may be electrically connected with the controller 220 to be updated and each of the first controller 231, the second controller 232, and the third controller 233 may include a storage space.

According to an exemplary embodiment, the controller 220 may be configured to receive an update request for the controller 220 to be updated, via the communication interface 210 from the external device 22. The external device 22 may be, for example, a mobile communication device. The controller 220 may be connected with the external device 22 via, for example, a USB port or Bluetooth communication. A server 21 may be configured to store update data regarding the controller 220 to be updated. The controller 220 may be configured to receive an update request via the external device 22 from the server 21 using the communication interface 210 and receive update data.

When the update request is received, the controller 220 may be configured to receive information indicating a remaining storage space of each of the first controller 231, the second controller 232, and/or the third controller 233. For example, the controller 220 may be configured to receive information regarding a size of a storage space which remains after a peripheral controller (e.g., the first controller 231, the second controller 232, and/or the third controller 233) stores its ROM binary.

According to an exemplary embodiment, the controller 220 may be configured to determine a peripheral controller to transmit previous version data among the first controller 231, the second controller 232, and the third controller 233 based on information indicating a remaining storage space and a size of the previous version data. For example, when the size of the previous version data is 10 MB, when the size of the remaining storage space of the first controller 231 is 6 MB, and when the size of the remaining storage space of the second controller 232 is 4 MB, the controller 220 may be configured to determine the first controller 231 and the second controller 232 as peripheral controllers to transmit previous version data.

The controller 220 may then be configured to divide previous version data of the controller 220 to be updated, based on the information indicating the remaining space. For example, the controller 220 may be configured to divide the previous version data into a first portion of 6 MB and a second portion of 4 MB. In addition, the controller 220 may be configured to transmit the divided previous version data to peripheral controllers. For example, the controller 220 may be configured to transmit a first portion of the previous version data to the first controller 231 and transmit a second portion of the previous version data to the second controller 232.

When the transmission of the divided previous version data is completed, the controller 220 may be configured to receive update data regarding the controller 220 from the external device 22 and perform the update using the update data. While the update according to the update request is in progress, the controller 220 may be configured to transmit a notification message for providing a notification that the update is in progress to a peripheral controller which stores previous version data among the first controller 231, the second controller 232, and/or the third controller 233.

According to an exemplary embodiment, when the update according to the update request is completed, the controller 220 may be configured to request one or more peripheral controllers to delete divided previous version data. Since there is no necessity of rollback when the update is completed, the previous version data may be deleted to prevent a storage space from being wasted.

According to an exemplary embodiment, when a connection with the external device 22 is lost while the update according to the update request is in progress, the controller 220 may be configured to perform rollback using previous version data stored in the first controller 231, the second controller 232, and/or the third controller 233. For example, when a connection with the external device 22 is lost or when an error occurs while the update is in progress, the controller 220 may be configured to notify the first controller 231, the second controller 232, and/or the third controller 233 that the error occurs. For another example, while the update is normally in progress, the controller 220 may be configured to transmit a message to the first controller 231, the second controller 232, and/or the third controller 233.

When the message is not transmitted during a particular period of time, the first controller 231, the second controller 232, and/or the third controller 233 may be configured to detect the occurrence of the error. When the occurrence of the error is detected, the controller 220 may be configured to receive previous version data stored in the first controller 231, the second controller 232, and/or the third controller 233 to perform rollback. In particular, the controller 220 may be configured to sequentially receive the divided previous version data from the first controller 231, the second controller 232, and/or the third controller 233. For example, the controller 220 may be configured to receive the first portion of the previous version data from the first controller 231 and receive the second portion of the previous version data from the second controller 232. The controller 220 may complete the rollback using the received previous version data.

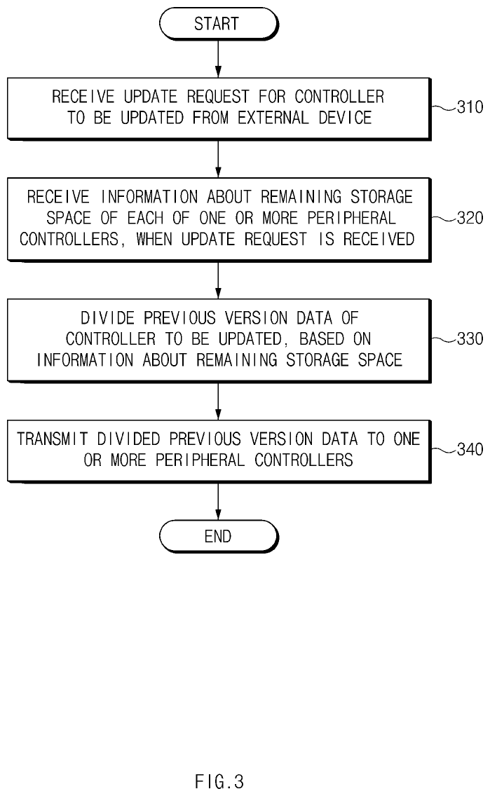

FIG. 3 is a flowchart illustrating a method for providing an update in a vehicle according to an exemplary embodiment of the present disclosure. Hereinafter, it may be assumed that an apparatus 200 for providing an update in FIG. 2 performs a process of FIG. 3. Furthermore, in a description of FIG. 3, an operation described as being performed by a vehicle may be understood as being executed by a controller 220 to be updated in the apparatus 200 for providing the update.

Referring to FIG. 3, in operation 310, the vehicle may be configured to receive an update request for a controller to be updated from an external device. For example, when new version software of the controller to be updated is registered with a server, the vehicle may be configured to receive the update request via the external device from the server. In operation 320, when the update request is received, the vehicle may be configured to receive information indicating a remaining storage space of each of one or more peripheral controllers. For example, the vehicle may be configured to receive information indicating a size of a remaining storage space of each of peripheral controllers to obtain a storage space for rollback.

In operation 330, the vehicle may be configured to divide previous version data of the controller to be updated, based on the information indicating the remaining storage space. For example, the vehicle may be configured to divide the previous version data into a plurality of portions, each of which has a size capable of being stored in the remaining storage space of the peripheral controller. The divided portions may be assigned to the peripheral controllers, respectively, based on the remaining storage spaces of the peripheral controllers. In operation 340, the vehicle may be configured to transmit the divided previous version data to the one or more peripheral controllers. For example, the vehicle may be configured to store each of the divided portions in the assigned peripheral controller. Thereafter, the vehicle may proceed with an update. When the update succeeds, the vehicle may be configured to delete the previous version data. When the update fails, the vehicle may be configured to perform rollback using the previous version data stored in the peripheral controllers.

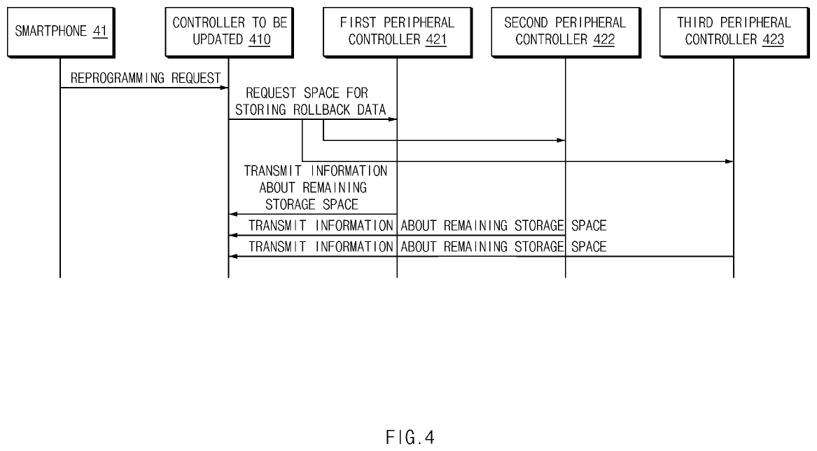

FIG. 4 is a flowchart illustrating a method for providing an update in a vehicle according to an exemplary embodiment of the present disclosure. Referring to FIG. 4, a smartphone 41 may function as an update management controller. The smartphone 41 may be configured to request a controller 410 to be updated to perform reprogramming (an update) of the controller 410 to be updated.

In response to the reprogramming request, the controller 410 may be configured to request a space for storing rollback data from a first peripheral controller 421, a second peripheral controller 422, and a third peripheral controller 423 to obtain the storage space for rollback. In response to the request of the controller 410 to be updated, each of the first peripheral controller 421, the second peripheral controller 422, and the third peripheral controller 423 may be configured to transmit information indicating a remaining storage space of each of the controllers 421, 422, 423 to the controller 410.

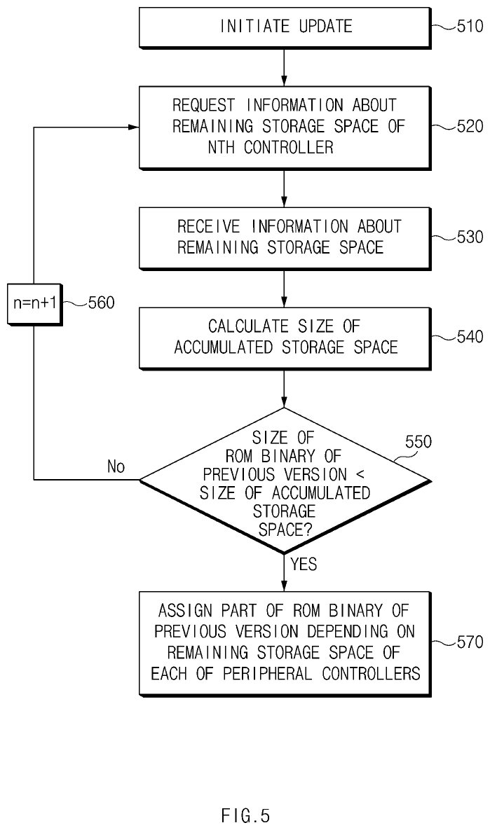

FIG. 5 is a flowchart illustrating a method for providing an update in a vehicle according to an exemplary embodiment of the present disclosure. Referring to FIG. 5, in operation 510, a controller may be configured to initiate an update based on a request of an external device. In operation 520, the controller may be configured to request a first controller to transmit information indicating a remaining storage space of the first controller. In operation 530, the controller may be configured to receive the information indicating the remaining storage space of the first controller from the first controller. In operation 540, the controller to be updated may be configured to calculate a size of an accumulated storage space.

In operation 550, the controller may be configured to determine whether the accumulated storage space is greater in size than a ROM binary of a previous version. When the ROM binary of the previous version is greater than or equal to in size the accumulated storage space, the controller may be configured to perform operations 520 to 550 again with respect to a second controller (operation 560). In particular, the size of the accumulated storage space may be calculated by adding a size of a remaining storage space of the first controller to a size of a remaining storage space of the second controller. When the accumulated storage space is greater in size than the ROM binary of the previous version, in operation 570, the controller may be configured to assign a part of the ROM binary of the previous version to each of peripheral controllers based on the remaining storage space of each of the peripheral controllers.

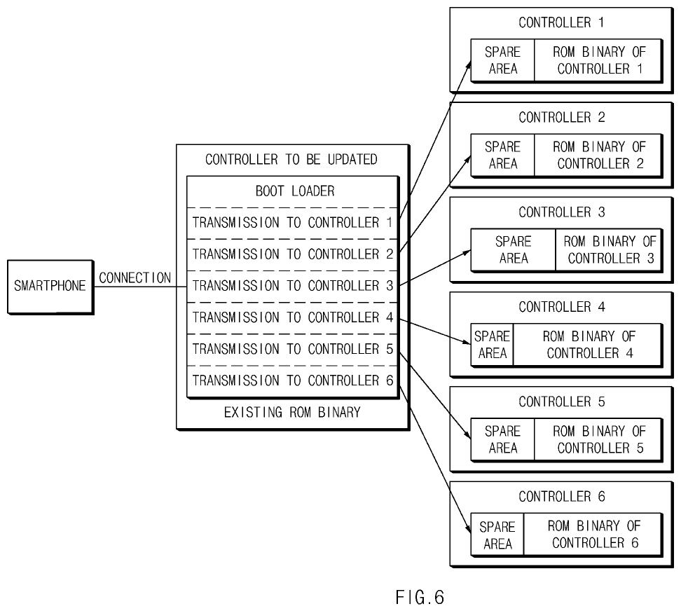

FIG. 6 is a drawing illustrating an exemplary operation of an apparatus for providing an update in a vehicle according to an exemplary embodiment of the present disclosure. Referring to FIG. 6, a controller to be updated may be connected with a smartphone. The controller may be configured to receive an update request from the smartphone. When the update request is received, the controller may be configured to store an existing ROM binary stored in the controller to be updated in another component for rollback when an update fails.

The controller may be configured to detect a spare area of a memory of each of peripheral controllers (e.g., controllers 1 to 6) to store the existing ROM binary. The controller may be configured to divide the existing ROM binary to fit a spare area of each of controllers 1 to 6 and transmit the divided portions to controllers 1 to 6, respectively. As a result, the existing ROM binary may be stored in the spare areas of controllers 1 to 6.

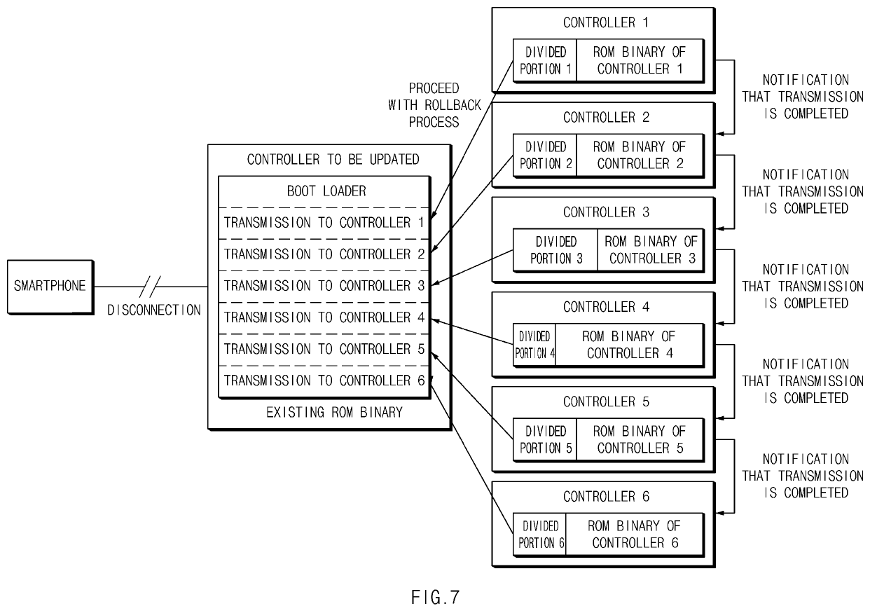

FIG. 7 is a drawing illustrating an exemplary operation of an apparatus for providing an update in a vehicle according to an exemplary embodiment of the present disclosure. Referring to FIG. 7, a controller to be updated may be disconnected from a smartphone during an update. When a connection between the controller to be updated and the smartphone is lost, the update may fail and rollback may be required. The controller may be configured to perform the rollback using portions of an existing ROM binary, which are stored in controllers 1 to 6.

Additionally, the controller may be configured to receive divided portion 1 of the existing ROM binary. When the transmission of controller 1 is completed, controller 1 may be configured to notify controller 2 that the transmission is completed. Controller 2 may then be configured to transmit divided portion 2 to the controller to be updated, in response to the notification that the transmission is completed. Thereafter, controllers 3 to 6 may be configured to sequentially transmit the divided portions of the existing ROM binary to the controller to be updated. When the transmission of controllers 1 to 6 is completed, the controller to be updated may be configured to recover the existing ROM binary.

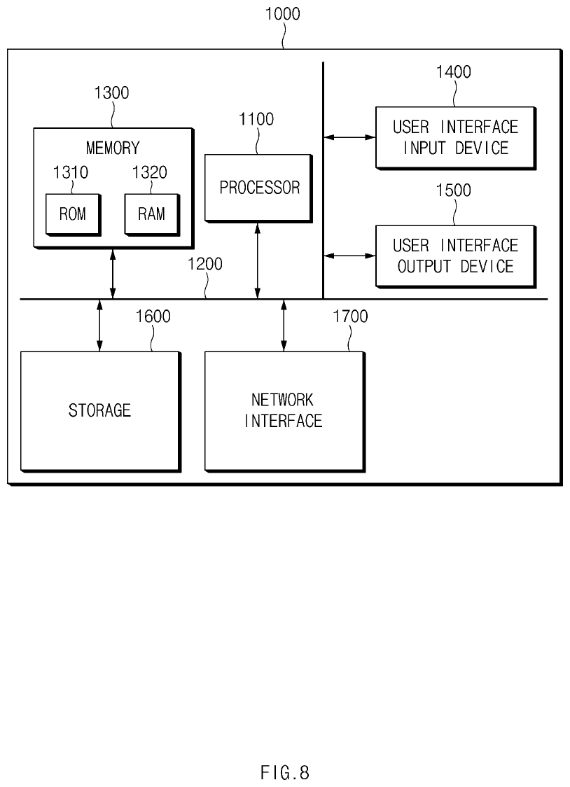

FIG. 8 is a block diagram illustrating a configuration of a computing system according to an exemplary embodiment of the present disclosure. Referring to FIG. 8, the above-mentioned apparatus according to an exemplary embodiment of the present disclosure may be implemented by device of the computing system. The computing system 1000 may include at least one processor 1100, a memory 1300, a user interface input device 1400, a user interface output device 1500, storage 1600, and a network interface 1700, which are connected with each other via a bus 1200.

Particularly, the processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory). Thus, the operations of the method or the algorithm described in connection with the exemplary embodiments disclosed herein may be embodied directly in hardware or a software module executed by the processor 1100, or in a combination thereof.

The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The apparatus and method for providing the update according an exemplary embodiment of the present disclosure may divide previous version data of a controller to be updated and store the divided data in other controllers when an external device is used as an update management controller to save costs of loading a management controller and communication costs and efficiently roll back software of the controller when an update error occurs. The apparatus for providing the update and a computer storage medium according an exemplary embodiment of the present disclosure may be configured to store update data in a memory for rollback only when updating a controller for adjusting a behavior of a vehicle to reduce the unit cost of manufacture which goes into the memory loaded into the vehicle. In addition, various effects directly or indirectly ascertained through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the exemplary embodiments. The scope of the present disclosure should be construed on the basis of the accompanying claims, and all the technical ideas within the scope equivalent to the claims should be included in the scope of the present disclosure.

What is claimed is:

1. An apparatus for providing an update in a vehicle, comprising:
a communication interface configured to communicate wiredly or wirelessly with an external device;
one or more peripheral controllers; and
a controller to be updated, electrically connected with the communication interface and the one or more peripheral controllers,
wherein the controller to be updated is configured to:
receive an update request for the controller to be updated, through the communication interface from the external device;
receive information indicating a remaining storage space of each of the one or more peripheral controllers, when the update request is received;
divide previous version data of the controller to be updated, based on the information indicating the remaining storage space; and
transmit the divided previous version data to the one or more peripheral controllers.

2. The apparatus of claim 1, wherein the controller to be updated is configured to perform rollback using the previous version data stored in the one or more peripheral controllers, when a connection with the external device is lost while an update according to the update request is in progress.

3. The apparatus of claim 2, wherein the controller to be updated is configured to sequentially receive the divided previous version data from the one or more peripheral controllers.

4. The apparatus of claim 1, wherein the controller to be updated is configured to receive update data regarding the controller to be updated from the external device, when the transmission of the divided previous version data is completed and perform an update using the update data.

5. The apparatus of claim 1, wherein the controller to be updated is configured to request the one or more peripheral controllers to delete the divided previous version data, when an update according to the update request is completed.

6. The apparatus of claim 1, wherein the controller to be updated is configured to transmit a notification message for providing a notification that an update is in progress to the one or more peripheral controllers, while the update according to the update request is in progress.

7. The apparatus of claim 1, wherein the controller to be updated is configured to determine a peripheral controller to transmit the previous version data among the one or more peripheral controllers based on the information indicating the remaining storage space and a size of the previous version data.

8. The apparatus of claim 1, wherein the external device is a mobile communication device, and the controller to be updated is configured to update data for the controller to be updated, via the mobile communication device from a server.

9. The apparatus of claim 1, wherein the controller to be updated is connected with the external device via a universal serial bus (USB) port.

10. The apparatus of claim 1, wherein the controller to be updated is connected with the external device via Bluetooth communication.

11. A method for providing an update in a vehicle, comprising:
receiving, by a controller, an update request for the controller to be updated, from an external device;
receiving, by a controller, information indicating a remaining storage space of each of one or more peripheral controllers, when the update request is received;
dividing, by a controller, previous version data of the controller to be updated, based on the information indicating the remaining storage space; and
transmitting, by a controller, the divided previous version data to the one or more peripheral controllers.

12. The method of claim 11, further comprising:
performing, by a controller, rollback using the previous version data stored in the one or more peripheral controllers, when a connection with the external device is lost while an update according to the update request is in progress.

13. The method of claim 11, further comprising:
receiving, by a controller, update data regarding the controller to be updated from the external device, when the transmission of the divided previous version data is completed; and
performing, by a controller, an update using the update data.

14. The method of claim 11, further comprising:
requesting, by a controller, the one or more peripheral controllers to delete the divided previous version data, when an update according to the update request is completed.

15. The method of claim 11, further comprising:
determining, by a controller, a peripheral controller to transmit the previous version data among the one or more peripheral controllers based on the information indicating the remaining storage space and a size of the previous version data.
